(19) United States
(12) Patent Application Publication
(10) Pub. No.: US 2015/0241849 A1
(43) Pub. Date: Aug. 27, 2015

(54) METHODS FOR IMPROVED TIMING OF DEVICES

(71) Applicant: Alex Jeffry Wessler, Decatur, IL (US)

(72) Inventor: Alex Jeffry Wessler, Decatur, IL (US)

(21) Appl. No.: 14/541,592

(22) Filed: Nov. 14, 2014

Related U.S. Application Data
(60) Provisional application No. 61/904,624, filed on Nov. 15, 2013.

(51) Int. Cl. G04F 1/00; B65D 33/16

(52) U.S. Cl. CPC G04F 1/00; B65D 33/1675

(57) ABSTRACT

An apparatus for timing is disclosed. the apparatus comprises a timer for measuring time, a switch for activating the timer, and a moving portion. The switch is configured to activate the timer upon movement of the moving portion. Methods for determining an amount of time of how long an apparatus has been opened, closed, or a combination thereof is also disclosed. The method includes associating a timer and a switch with the apparatus, the apparatus comprising a portion that moves and configuring the switch to activate the timer upon movement of the portion of the apparatus.

### CROSS-REFERENCE TO RELATED APPLICATIONS

This application claims priority to U.S. Provisional Application No. 61/904,624, filed Nov. 15, 2013, the contents of the entirety of which is incorporated by this reference.

### BACKGROUND OF THE INVENTION

Devices exist for opening and closing various openings on apparatus. However, most of them do not include ways to tell how much time has elapsed since the last time the device was opened or closed.

For instance, while refrigerators and drawers within them may be opened and closed, there is no way to determine when food in a drawer was last accessed without writing down the time or setting a timer. Further, even though devices exist for holding closed a bag of food, such as chips, once the bag is opened and placed back in the pantry, there is no way for a user to ascertain how long it has been since the bag was last opened.

Thus, needs exist for being able to easily determine an amount of time that has elapsed since the last time an opening or a bag was last opened.

### SUMMARY OF THE INVENTION

In each of its various embodiment, the present invention fulfills this need and discloses methods of determining an amount of time that has elapsed since the last time an opening or a bag was last opened.

In one embodiment, an apparatus comprises a timer for measuring time, a switch for activating the timer, and a moving portion. The switch is configured to activate the timer upon movement of the moving portion.

In another embodiment, a method for determining how long an apparatus has been opened, closed, or a combination thereof comprises associating a timer and a switch with the apparatus. The apparatus comprises a portion that moves. The method further comprises configuring the switch to activate the timer upon movement of the portion of the apparatus.

In a further embodiment, a method for determining an amount of time from when a clip was previously opened is disclosed. The method comprises attaching a timer and a switch to the clip and configuring the switch to activate the timer upon opening of the clip.

### BRIEF DESCRIPTION OF THE DRAWINGS

FIG. 1A shows one embodiment of a side view of an apparatus for measuring time of the present invention, wherein the apparatus is a bag clip. FIG. 1B shows a top view of the apparatus of FIG. 1A.

FIG. 2 shows another embodiment of an apparatus for measuring time of the present invention, where the apparatus is a garage door.

FIG. 3 shows an additional embodiment of an apparatus for measuring time of the present invention, where the apparatus is a door or drawer of a refrigerator.

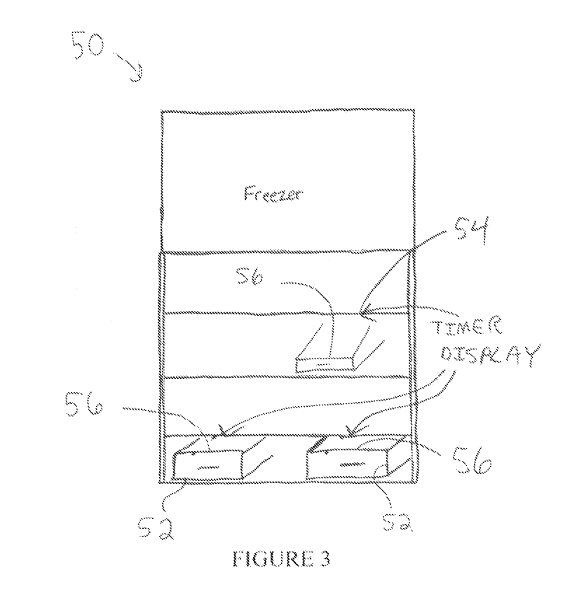

FIG. 4 shows yet a further embodiment of an apparatus for measuring time of the present invention, where the apparatus is an oven door.

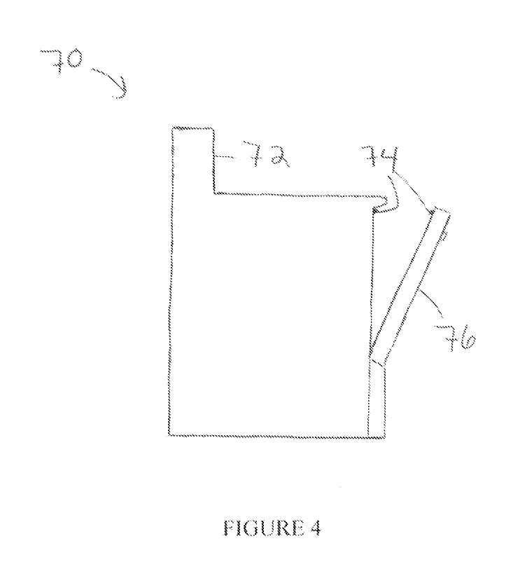

### DETAILED DESCRIPTION OF THE INVENTION

In one embodiment, an apparatus comprises a timer for measuring time, a switch for activating the timer, and a moving portion. The switch is configured to activate the timer upon movement of the moving portion. The timer may be a digital timer. In another embodiment, the apparatus may include a second timer. At least one of the timers may be activated manually. The apparatus may be a clip, a garage door, an oven door, a refrigerator door, or a refrigerator drawer.

In a further embodiment, a method for determining how long an apparatus has been opened, closed, or a combination thereof is disclosed. The method may include: associating a timer and a switch with the apparatus, the apparatus comprising a portion that moves; and configuring the switch to activate the timer upon movement of the portion of the apparatus. The switch may be configured to start, stop, or a combination thereof the timer upon movement of the portion of the apparatus. The apparatus may be selected from the group consisting of a clip, a garage door, an oven door, a refrigerator door, and a refrigerator drawer. The portion that moves may be a door, a drawer, or a hinge of the apparatus.

In a further embodiment, a method for determining an amount of time from when a clip was previously opened is disclosed. The method comprises attaching a timer and a switch to the clip, and configuring the switch to activate the timer upon opening of the clip. The switch may be configured to reset the timer upon opening of the clip. The clip may be a binder clip or a spring clip. The clip may include a grasping portion and at least one handle, the grasping portion having at least two members that exert pressure on each other when the clip is closed, wherein the at least one handle is configured to force the at least two members apart. The switch may activate when the at least two members of the grasping portion are forced apart. The method may also include associating a display with the timer, wherein the display is configured to show the amount of the time. The method may also include attaching a manual switch to the timer, wherein the manual switch is configured to activate the timer.

In yet a further embodiment, the timer may be associated with a device for remotely sending the data from the timer to a remote device such that the data may be monitored remotely. In such manner, a user of the apparatus or methods described herein may be able to access the data without being physically present where the apparatus is located.

### Example 1

### Automatic Bag Clip Timer

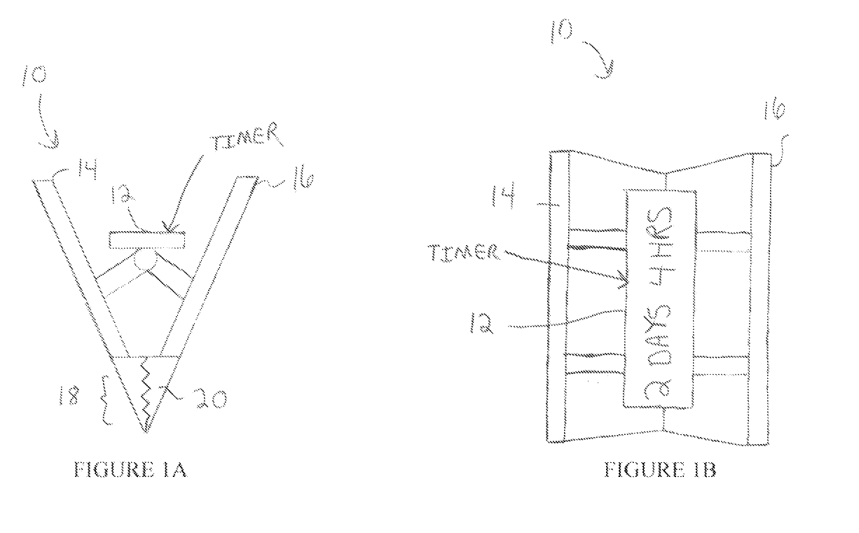

FIGS. 1A and 1B shows a side view and a top view, respectively, of a bag clip 10 having a timer 12 of the present invention. In this embodiment, the bag clip 10 is a binder style clip, but any type of clip that is able to hold a bag closed will work. The timer 12 is operatively configured to automatically reset when the bag clip 10 is closed. As known in the art, the bag clip 10 is operated by pressing portions 14 and 16 together in order to open the grasping portion 18 of the bag clip 10. In this embodiment, a switch 20 is configured on the grasping portion 18 of the bag clip 10 such that upon closing of the grasping portion 18, the switch 20 activates by resetting and starting the time upon placement of the bag clip 10 on a bag which may have food placed therein. In this manner, a user of the bag clip 10 is able to ascertain how much time has elapsed since the last time a bag of food was opened in order to determine the general freshness of the food.

Although not shown, the bag clip 10 may be associated with a second timer that may be manually activated to be turned on and off the first time a bag of food is opened. Alternatively, the timer 12 may also be configured with a second manual switch that may be activated the first time a bag of food is opened. In this manner, a user of the bag clip 10 may be able to ascertain an amount of time that has elapsed since the bag of food was first opened, thus enabling the user to see how fresh the food is.

In addition to being able to tell the freshness of the food, the bag clip 10 and associated timer 12 enables a user to ascertain whether or not the bag of the food was even opened or closed to tell if someone has accessed the food.

As will be appreciated by one of ordinary skill in the art, the timer 12 may also be associated with other devices used for opening/closing other types of foodstuffs or beverages and the method disclosed herein may be applicable to other types of devices including, but not limited to, caps on bottles that either flip open and closed, caps on containers that screw on and off, etc.

### Example 2

### Garage Door Access Timer

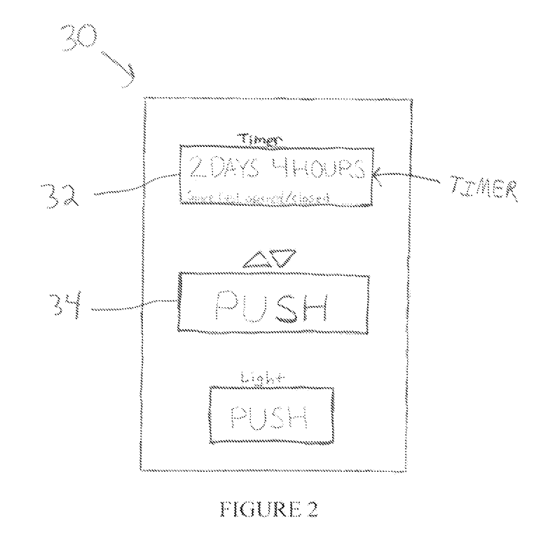

FIG. 2 shows a garage door opener of the present invention generally at 30. In this embodiment, the garage door opener 30 is wirelessly connected to a garage door opener (not shown) which is connected to a garage door (not shown). The garage door opener 30 includes a timer 32 that automatically resets when a switch associated with the garage door is activated by opening or closing of the garage door, or when a switch associated with a button 34 of the garage door opener 30 that activates when button 34 is depressed. The garage door opener 30 may also be associated with a second timer 34 that does not reset when the garage door is opened or closed, but rather is configured to reset manually upon pushing of the second timer 34.

This example enables a user of the garage door opener 30 to use the timer 32 and/or 34 as a security monitoring system that can identify access (wanted or unwanted) and time from access of the garage door. The garage door opener 30 may also be used as an all-purpose timer.

### Example 3

### Refrigerator Drawer/Compartment Door Timer

This example shows a refrigerator/freezer combination generally at 50 without a refrigerator door. The drawers or compartments 52 of the refrigerator may have a timer 54 with a display. The drawers of compartments 52 are also associated with switches 56 that are configured to automatically set or reset the timer 54 upon opening/closing of the drawers 52. The switches 56 may be metal contacts that are activated upon opening/closing of the drawers 52. The timer 54 may begin when the drawer 52 closes which may help gauge freshness of food stored in the drawer 52, monitor access (whether wanted or unwanted), or help establish the shelf-life or purchase date of the food stored within the drawers 52.

In another embodiment, the refrigerator/freezer combination 50 may also be associated with a second timer that does not automatically reset upon opening or closing of the drawers 52. The second timer can be manually reset in order to customize setting or resetting of the second timer to measure a desired amount of time associated with the refrigerator/freezer combination 50.

### Example 4

### Oven Door Open/Close Timer

This example shows an oven generally at 70. The oven is associated with a timer 72 operatively connected to a switch 74. The timer 72 is configured to automatically reset each time a door 76 of the oven 70 is opened or closed. In one embodiment, the timer 72 automatically resets when the switch 74 associated with the door 76 is opened and starts when the door 76 is closed. The switch 74 may have metal contacts that activate the switch 74 when the door 76 opens/closes.

The timer 72 associated with the oven 70 enables someone to ascertain the last time the door 76 was opened/closed in order to assist someone in using the oven for cooking or baking. The timer 72 may even help prevent energy loss from someone over opening-the door 76 of the oven 70.

The present invention has been described with reference to certain exemplary and illustrative embodiments, compositions and uses thereof. However, it will be recognized by persons having ordinary skill in the art that various substitutions, modifications or combinations of any of the exemplary embodiments may be made without departing from the scope of the invention. Thus, the invention is not limited by the description of the exemplary and illustrative embodiments, but rather by the appended claims.

1. A clip, comprising:
a timer for measuring time;
a switch for activating the timer;
a moving portion;
wherein the switch is configured to activate the timer upon movement of the moving portion.

2. The clip of claim 1, wherein the timer is a digital timer.

3. The clip of claim 1, further comprising a second timer.

4. The clip of claim 3, wherein the second timer is activated manually.

5. The clip of claim 1, further comprising a means for remotely sending data associated with the timer.

6. The clip of claim 1, wherein the clip is a binder clip or a spring clip.

7. A method for determining how long a clip has been opened, closed, or a combination thereof, the method comprising:
associating a timer and a switch with the clip, the clip comprising a portion that moves; and
configuring the switch to activate the timer upon movement of the portion of the clip.

8. The method according to claim 7, wherein configuring the switch to activate the timer comprises configuring the switch to start, stop, or a combination thereof the timer upon movement of the portion of the clip.

9. The method according to claim 7, wherein the portion that moves is a hinge.

10. The method according to claim 7, further comprising placing the clip on a container.

11. The method according to claim 10, wherein the container is a bag.

12. The method according to claim 7, further comprising associating the timer with a device that is able to remotely send data generated by the timer.

13. The method according to claim 7, wherein the clip is a spring clip or a binder clip.

14. A method for determining an amount of time from when a clip was previously opened, the method comprising:
attaching a timer and a switch to the clip; and
configuring the switch to activate the timer upon opening of the clip.

15. The method according to claim 14, wherein the switch is configured to reset the timer upon opening of the clip.

16. The method according to claim 14 or 15, wherein the clip comprises a binder clip or a spring clip.

17. The method according to claim 14, wherein the clip comprises a grasping portion and at least one handle, the grasping portion having at least two members that exert pressure on each other when the clip is closed, wherein the at least one handle is configured to force the at least two members apart.

18. The method according to claim 14, wherein the switch activates when the at least two members of the grasping portion are forced apart.

19. The method according to claim 14, further comprising associating a display with the timer, wherein the display is configured to show the amount of the time.

20. The method according to claim 14, further comprising attaching a manual switch to the timer, wherein the manual switch is configured to activate the timer.

21-22. (canceled)
